(19) United States
(12) Patent Application Publication
(10) Pub. No.: US 2010/0245750 A1
(43) Pub. Date: Sep. 30, 2010

(54) Wiring Structure Of Liquid Crystal Display Device And Liquid Crystal Display Device

(75) Inventors: Yen-fen LIN, Xizhi City (TW); Han-tung Hsu, Bade City (TW)

Correspondence Address: MORRIS MANNING MARTIN LLP, 3343 PEACHTREE ROAD, NE, 1600 ATLANTA FINANCIAL CENTER, ATLANTA, GA, 30326, US

(73) Assignee: Chunghwa Picture Tubes, Ltd., Taoyuan (TW)

(21) Appl. No.: 12/496,445

(22) Filed: Jul. 1, 2009

(30) Foreign Application Priority Data
Mar. 26, 2009 (TW) 098204804

(51) Int. Cl. G02F 1/1345; G02F 1/1343

(52) U.S. Cl. 349/149; 349/139

(57) ABSTRACT

A wiring structure of a liquid crystal display device and a liquid crystal display device are disclosed. The wiring structure of the liquid crystal display device includes a substrate, a plurality of electrical elements, and a plurality of wirings. The electrical elements are disposed on the substrate to generate a plurality of electrical signals. The wirings are coupled to the electrical elements to transmit the electrical signals. The wirings include inner wirings and an outermost peripheral wiring. The outermost peripheral wiring and the inner wirings have different wiring patterns. After the liquid crystal display device is cut and polished, by distinguishing the wiring patterns of both the outermost peripheral wiring and the inner wirings, the existence of the outermost peripheral wiring shows that the outermost peripheral wiring is not polished and removed. Therefore, a problem of output signals being affected due to the polished and removed wirings can be decreased.

### TECHNICAL FIELD OF THE INVENTION

The present invention relates to a wiring structure, and more particularly to a wiring structure of a liquid crystal display device which can easily be distinguished.

### BACKGROUND OF THE INVENTION

A conventional wiring structure around the edges of a liquid crystal display device is a straight-line pattern. However, the development of the liquid crystal display device is progressing toward the widescreen types, therefore the edge areas for wirings are narrower than before. In addition, according to design with increased substrate utilization rate, distances between the wirings of the liquid crystal display device are closer. In another aspect, design of a gate driving integrated circuit (IC) tends to be chip on glass (COG), that is, the driving integrated circuit is manufactured on an array substrate. Timing signals are transmitted via the wirings from a source driving integrated circuit to the gate driving integrated circuit. In order to prevent the timing signals from distortion, the wiring areas are enlarged for reducing resistance. However, because the areas inside the liquid crystal display device are limited, the wirings are often closer to the edges being cut and polished.

A glass substrate is usually cut into a plurality of display panels, for example, six pieces of display panels. Accordingly, the glass substrate needs to be proceeded with the cutting process for separating into the display panels. The display panels will have sharp edges after the glass substrate is cut, and the sharp edges need to be polished when considering the stress and safety of the workers. The wirings around the edges of the display panel still remain a straight-line pattern before and after the edges of the display panel are polished, so it is difficult for the workers to distinguish a border of the wirings around the edges of the display panel. Please refer to FIG. 1A and FIG. 1B. FIG. 1A illustrates a liquid crystal display device 100 before panel edges thereof are polished. FIG. 1B illustrates the liquid crystal display device 100 after panel edges thereof are polished. When the liquid crystal display device 100 proceeds to be polished, wiring areas are too easily polished and removed. As a result, a part of an outermost peripheral wiring 102 in FIG. 1A is polished and removed or the outermost peripheral wiring 102 is totally polished and removed as shown in FIG. 1B. Resistance of the wiring areas is accordingly changed to affect output signals, and display quality of the liquid crystal display device 100 is thus abnormal.

The conventional method to prevent the outermost peripheral wiring from being polished and removed is to make a mark at a specific position of each side of the liquid crystal display device. Then, each mark is utilized to indicate a polished edge of each side of the liquid crystal display device. The conventional method has to add a step of making the mark in the manufacturing processes of the liquid crystal display device, and only the wirings adjacent to the marks at the specific positions will not be polished and not be removed, however, the other wirings which are not adjacent to the marks might still be polished and removed.

Therefore, there is a need to solve the above-mentioned problem that the straight-line pattern wirings of the liquid crystal display device are not easily distinguishable and thus polished and removed. The above-mentioned problem affects the output signals and leads to the abnormal display quality of the liquid crystal display device.

### SUMMARY OF THE INVENTION

A primary objective of the present invention is to provide a wiring structure of a liquid crystal display device, such that the wiring structure can easily be viewed and distinguished before and after the liquid crystal display device is cut and polished. As a result, it can easily be distinguished whether the wiring structure of the liquid crystal display device is polished and removed.

The wiring structure of the liquid crystal display device according to the present invention comprises a substrate, a plurality of electrical elements, and a plurality of wirings. The electrical elements are disposed on the substrate to generate a plurality of electrical signals for displaying an image. The wirings are coupled to the electrical elements to transmit the electrical signals. The wirings comprise a plurality of inner wirings and an outermost peripheral wiring. The outermost peripheral wiring has a wiring pattern which is different from that of the inner wirings. The outermost peripheral wiring which is disposed between two ends of each side of the liquid crystal display device is a curve pattern. The curve pattern is a uniform pattern or a non-uniform pattern. The uniform pattern is one selected from a group consisting of square wave pattern, semi-circular pattern, triangular pattern, wave pattern, trapeziform pattern, and polygonal pattern.

The outermost peripheral wiring and the inner wirings have different wiring patterns according to the wiring structure of the present invention liquid crystal display device. After the liquid crystal display device is cut and polished, the workers can easily know whether the wiring areas are changed or not by distinguishing the wiring patterns of both the outermost peripheral wiring and the inner wirings are still different. If the wiring patterns of both the outermost peripheral wiring and the inner wirings are the same, that means the outermost peripheral wiring is polished and removed. As a result, it can be deduced that the output signals via the wirings will be affected, hence, abnormal display quality of the liquid crystal display device can be avoided.

### BRIEF DESCRIPTION OF THE DRAWINGS

FIG. 1A illustrates a liquid crystal display device before panel edges thereof are polished;

FIG. 1B illustrates the liquid crystal display device after panel edges thereof are polished;

FIG. 2 illustrates a wiring structure of a liquid crystal display device according to a first embodiment of the present invention;

FIG. 3A illustrates a diagram representing one corner of the wiring structure of the liquid crystal display device shown in FIG. 2 before the edges of the liquid crystal display device are polished;

FIG. 3B illustrates a diagram representing the outermost peripheral wiring in FIG. 3A which has been polished and removed;

FIG. 3C illustrates a diagram representing the outermost peripheral wiring shown in FIG. 3A which is not removed after the edges of the liquid crystal display device are polished;

FIG. 4 illustrates a wiring structure of a liquid crystal display device according to a second embodiment of the present invention; and

FIG. 5 illustrates a wiring structure of a liquid crystal display device according to a third embodiment of the present invention.

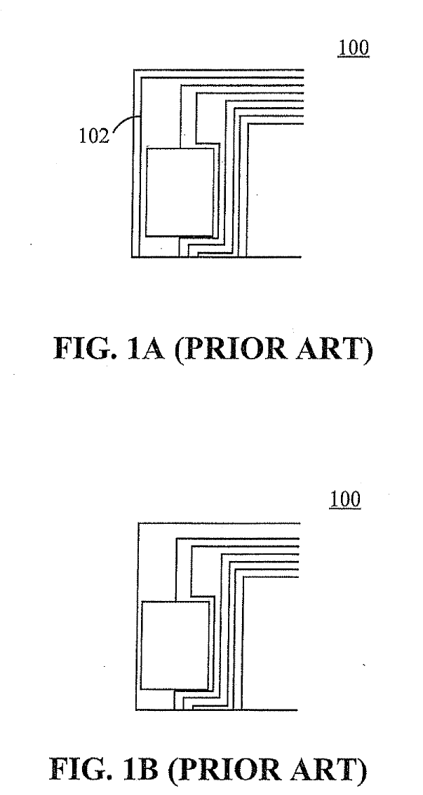

### DETAILED DESCRIPTION OF THE INVENTION

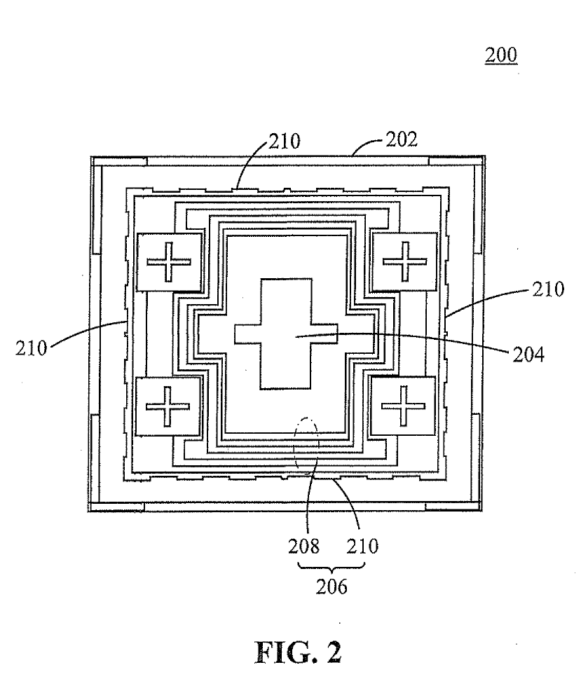

Please refer to FIG. 2. FIG. 2 illustrates a wiring structure of a liquid crystal display device 200 according to a first embodiment of the present invention. The wiring structure of the liquid crystal display device 200 comprises a substrate 202, a plurality of electrical elements 204, and a plurality of wirings 206. The substrate 202 is a glass substrate. The electrical elements 204 are disposed on the substrate 202 to generate a plurality of electrical signals for displaying an image. The wirings 206 are coupled to the electrical elements 204 to transmit the electrical signals. The wirings 206 comprise a plurality of inner wirings 208 and an outermost peripheral wiring 210. The outermost peripheral wiring 210 has a wiring pattern which is different from that of the inner wirings 208. The outermost peripheral wiring 210 which is disposed between two ends of each side of the liquid crystal display device is a curve pattern, that is, not a straight-line pattern. For example, the wiring pattern of the outermost peripheral wiring 210 which is disposed between two ends of each side of the liquid crystal display device is a square wave pattern. The curve pattern is a uniform pattern or a non-uniform pattern. The outermost peripheral wirings 210 of the four sides of the liquid crystal display device are uniform patterns, e.g. a uniform square wave pattern. Each outermost peripheral wiring 210 has a midpoint. The wiring patterns on both sides of the midpoint are symmetrical.

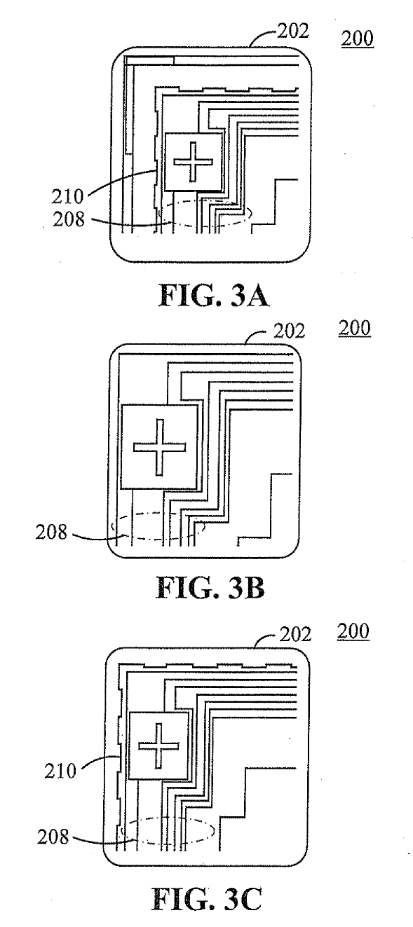

Please refer to FIG. 3A to FIG. 3C. FIG. 3A illustrates a diagram representing one corner of the wiring structure of the liquid crystal display device 200 shown in FIG. 2 before the edges of the liquid crystal display device are polished. FIG. 3B illustrates a diagram representing the outermost peripheral wiring 210 shown in FIG. 3A which has been polished and removed. FIG. 3C illustrates a diagram representing the outermost peripheral wiring 210 shown in FIG. 3A which is not removed after the edges of the liquid crystal display device are polished. To achieve the purpose of easily distinguishing whether or not the wirings of the edges are polished and removed, it is understood and easily distinguished from FIG. 3A that the outermost peripheral wiring 210 has a wiring pattern different from that of the inner wirings 208. If the outermost peripheral wiring 210 in FIG. 3A is polished and removed as shown in FIG. 3B, that is, the remaining outermost peripheral wiring and the inner wirings 208 have the same wiring pattern, i.e. a straight-line pattern, this represents that a part of the outermost peripheral wiring 210 or the total part of the outermost peripheral wiring 210 has been polished and removed. Resistance of the outermost peripheral wiring 210 is thus changed, therefore, it is not the original resistance of the outermost peripheral wiring 210. The workers can easily distinguish polished edges by viewing with their eyes or utilizing a microscope to deduce that the display quality of the liquid crystal display device might be abnormal. In contrast, when the outermost peripheral wiring 210 and the inner wirings 208 still have different wiring patterns as shown in FIG. 3C after the liquid crystal display device in FIG. 3A is polished, this represents the outermost peripheral wiring 210 is not polished and not removed. Accordingly, the display quality of the liquid crystal display device might not be affected by the polishing process.

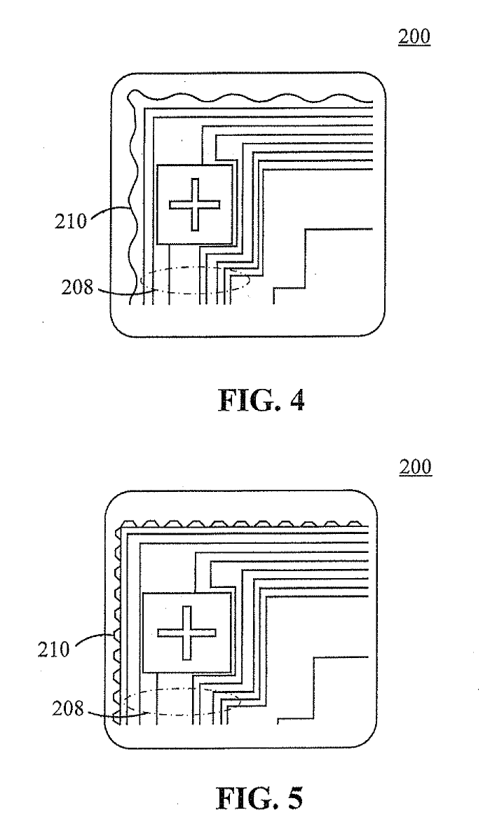

Please refer to FIG. 4. FIG. 4 illustrates a wiring structure of a liquid crystal display device 200 according to a second embodiment of the present invention. The wiring pattern of the outermost peripheral wiring 210 in FIG. 4 is a wave pattern. Since the primary objective of the present invention is to be able to easily distinguish the wiring pattern of the outermost peripheral wiring 210 from that of the inner wirings 208 after the liquid crystal display device is cut and polished, as long as the outermost peripheral wiring 210 has a wiring pattern different from that of the inner wirings 208, the primary objective of the present invention can be achieved. Please refer to FIG. 5. FIG. 5 illustrates a wiring structure of a liquid crystal display device 200 according to a third embodiment of the present invention. In the present embodiment, the wiring pattern of the outermost peripheral wiring 210 is formed by a plurality of trapeziform patterns, and an interval between adjacent trapeziform patterns is a specific distance.

The outermost peripheral wiring 210 in the above-mentioned embodiments is a uniform pattern. However, other than the uniform patterns shown in FIG. 2, and FIGS. 4-5, the uniform pattern can also be one selected from a group consisting of semi-circular pattern, triangular pattern, polygonal pattern, and any other geometric patterns. Of course, the outermost peripheral wiring 210 can be a non-uniform pattern. As long as the wiring pattern of the outermost peripheral wiring 210 is different from that of the inner wirings 208, the primary objective of the present invention can be achieved.

The outermost peripheral wiring 210 and the inner wirings 208 are made of metal for transmitting the electrical signals as mentioned above. The electrical elements 204 comprise at least one gate driving integrated circuit, at least one source driving integrated circuit, and other elements needed by the liquid crystal display device to display an image. The gate driving integrated circuit is utilized for driving pixels. The source driving integrated circuit is utilized for outputting display signals to the pixels.

The outermost peripheral wiring and the inner wirings have different wiring patterns according to the wiring structure of the liquid crystal display device of the present invention. After the liquid crystal display device is cut and polished, the workers can easily distinguishing whether the wiring areas are changed or not by viewing the wiring patterns of both the outermost peripheral wiring and the inner wirings are still different. If the wiring patterns of both the outermost peripheral wiring and the inner wirings are the same, that means the outermost peripheral wiring is polished and removed. As a result, it can be deduced that the output signals via the wirings will be affected. Therefore, abnormal display quality of the liquid crystal display device can be avoided. Furthermore, the wiring pattern of the outermost peripheral wiring can be regarded as a mark when the liquid crystal display device is cut and polished. Therefore, the step of making an additional mark at a specific position in the conventional methods can be omitted. Because the outermost peripheral wiring and the inner wirings have different wiring patterns, the workers can easily distinguish whether the outermost peripheral wiring is polished and removed or not. In contrast, only wirings adjacent to the marks at the specific positions can be distinguished in the conventional methods. Finally, when mura occurs in some areas of the liquid crystal display device, the wiring patterns adjacent to the mura in the areas can be distinguished first for identifying whether the wiring patterns adjacent to the mura in the areas are polished and removed. That is, the areas of mura can be fastly identified.

While the preferred embodiments of the present invention have been illustrated and described in detail, various modifications and alterations can be made by persons skilled in this art. The embodiment of the present invention is therefore described in an illustrative but not restrictive sense. It is intended that the present invention should not be limited to the particular forms as illustrated, and that all modifications and alterations which maintain the spirit and realm of the present invention are within the scope as defined in the appended claims.

What is claimed is:

1. A wiring structure of a liquid crystal display device, comprising:
a substrate;
a plurality of electrical elements disposed on the substrate, for generating a plurality of electrical signals for displaying an image;
a plurality of wirings coupled to the electrical elements, for transmitting the electrical signals,
wherein the wirings comprise a plurality of inner wirings and an outermost peripheral wiring, and the outermost peripheral wiring has a wiring pattern different from that of the inner wirings.

2. The wiring structure of the liquid crystal display device of claim 1, wherein the outermost peripheral wiring between two ends of each side of the liquid crystal display device is a curve pattern.

3. The wiring structure of the liquid crystal display device of claim 2, wherein the curve pattern is a uniform pattern.

4. The wiring structure of the liquid crystal display device of claim 3, wherein the uniform pattern is one selected from a group consisting of square wave pattern, semi-circular pattern, triangular pattern, wave pattern, trapeziform pattern, and polygonal pattern.

5. The wiring structure of the liquid crystal display device of claim 2, wherein the curve is a non-uniform pattern.

6. The wiring structure of the liquid crystal display device of claim 1, wherein the inner wirings are made of metal.

7. The wiring structure of the liquid crystal display device of claim 1, wherein the outermost peripheral wiring is made of metal.

8. The wiring structure of the liquid crystal display device of claim 1, wherein the electrical elements comprise at least one gate driving integrated circuit.

9. The wiring structure of the liquid crystal display device of claim 1, wherein the electrical elements comprise at least one source driving integrated circuit.

10. A liquid crystal display device comprising the wiring structure of the liquid crystal display device of claim 1.
